(19) United States
(12) Patent Application Publication
(10) Pub. No.: US 2026/0236060 A1
(43) Pub. Date: Aug. 13, 2026

(54) FOLDABLE DISPLAY SCREEN AND METHOD FOR MANUFACTURING GLASS

(71) Applicants: Chengdu BOE Optoelectronics Technology Co., Ltd., Chengdu, Sichuan (CN); BOE Technology Group Co., Ltd., Beijing (CN)

(72) Inventors: Shiyou WANG, Beijing (CN); Tiejun BI, Beijing (CN); Yongxiao GAO, Beijing (CN); Qiang TANG, Beijing (CN); Zhihui WANG, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/707,176

(22) PCT Filed: Aug. 1, 2023
(86) PCT No.: PCT/CN2023/110517

§ 371 Date: May 1, 2026

(30) Foreign Application Priority Data
Aug. 31, 2022 (CN) 202211058086.4

(51) Int. Cl. G06F 1/16; C03C 15/00; C03C 21/00; G06F 1/20

(52) U.S. Cl. CPC G06F 1/1616; C03C 15/00; C03C 21/002; G06F 1/1656; G06F 1/20

(57) ABSTRACT

Provided is a foldable display screen, including: glass, wherein the glass includes a recess formed in a first plane of the glass; wherein the recess is disposed in a bendable region of the foldable display screen, the recess extends in a lengthwise direction of the bendable region and runs through the first plane, and a distance between two side surfaces of the recess gradually increases along a direction close to the first plane; wherein each of the side surfaces of the recess includes a first arcuate surface and a second arcuate surface, wherein the first arcuate surface is connected to the first plane and curved towards a bottom surface of the recess, the second arcuate surface is connected to the bottom surface of the recess and curved towards the first plane, and the first arcuate surface is connected to the second arcuate surface.

### CROSS-REFERENCE TO RELATED APPLICATIONS

The application is a U.S. national stage of international application No. PCT/CN2023/110517, field on Aug. 1, 2023, which claims priority to Chinese Patent Application No. 202211058086.4, filed on Aug. 31, 2022 and entitled “FOLDABLE DISPLAY SCREEN AND METHOD FOR MANUFACTURING GLASS,” the contents of each are herein incorporated by reference in their entireties.

### TECHNICAL FIELD

The present disclosure relates to the technical field of display device, and in particular, relates to a foldable display screen and a method for manufacturing glass.

### BACKGROUND

Existing flexible foldable display screens are mainly made of organic materials, resulting in low impact strength and serious creases of the foldable display screens. In recent years, to improve the impact strength, flexible glass has been used in a few foldable display screens, but the thickness of the flexible glass is below 50 μm, and the common thickness is 30 μm to ensure the bending performance. Because the thickness of the whole glass is thin, compared with the original organic material, the impact performance gain brought by the flexible glass is not obvious.

### SUMMARY

According to some embodiments of the present disclosure, a foldable display screen is provided. The foldable display screen includes glass, wherein the glass includes a recess formed in a first plane of the glass; wherein the recess is disposed in a bendable region of the foldable display screen, the recess extends in a lengthwise direction of the bendable region, and runs through the first plane, and a distance between two side surfaces of the recess gradually increases along a direction close to the first plane;

wherein each of the side surfaces of the recess includes a first arcuate surface and a second arcuate surface, wherein the first arcuate surface is connected to the first plane and curved towards a bottom surface of the recess, the second arcuate surface is connected to the bottom surface of the recess and curved towards the first plane, and the first arcuate surface is connected to the second arcuate surface.

In some embodiments, the bottom surface of the recess is parallel to the first plane, and a distance between the bottom surface of the recess and a second plane, away from the first plane, of the glass is greater than or equal to 30 μm and less than or equal to 50 μm.

In some embodiments, a distance between a side edge, close to the bottom surface of the recess, of an orthographic projection of the side surface of the recess on the first plane and a side edge, away from the bottom surface of the recess, of the orthographic projection of the side surface of the recess on the first plane is greater than or equal to 5 mm and less than or equal to 10 mm.

In some embodiments, the first arcuate surface and the second arcuate surface are both circular arcuate surfaces, and curvature radii of cross-sections of the two arcuate surfaces are both greater than or equal to 10 mm.

In some embodiments, the foldable display screen further includes: a transparent filling layer configured to fill the recess, wherein a refractive index of the transparent filling layer is greater than or equal to 1.41 and less than or equal to 1.61.

In some embodiments, the foldable display screen further includes: a display panel, a cover layer, and a heat dissipation support layer, wherein the cover layer is configured to cover and protect the display panel, and the glass is disposed in the cover layer.

In some embodiments, a surface of the glass is coated with potassium ions and/or sodium ions.

According to some embodiments of the present disclosure, a method for manufacturing glass is provided. The method is applicable to manufacturing the glass in the foldable display screen as described above. The method includes:
forming a recess having a predetermined depth by thinning a selected region in a first plane of a glass substrate, wherein the selected region corresponds to a bendable region of the foldable display screen, and a non-selected region in the first plane corresponds to a non-bendable region of the foldable display screen;
forming the glass by cutting the thinned glass substrate; and
strengthening an impact strength of the glass.

In some embodiments, strengthening the impact strength of the glass includes: comparing the predetermined depth of the recess with a depth threshold; and in a case where the predetermined depth is less than or equal to the depth threshold, performing a single chemical strengthening treatment on the non-bendable region and the bendable region of the glass; or in a case where the predetermined depth is greater than the depth threshold, performing n chemical strengthening treatments on the glass, wherein n is a positive integer greater than or equal to 2.

In some embodiments, a chemical strengthening treatments in the n chemical strengthening treatments are performed on both the non-bendable region and the bendable region of the glass, wherein a is a positive integer greater than or equal to 1 and less than or equal to n−1; and n−a chemical strengthening treatments in the n chemical strengthening treatments are performed only on the non-bendable region of the first plane, such that a thickness of a strengthening layer in the non-bendable region is greater than a thickness of a strengthening layer in the bendable region.

In some embodiments, performing n chemical strengthening treatments on the glass includes: shielding the bendable region of the glass by providing a strengthening shielding layer; performing a first chemical strengthening treatment on the non-bendable region of the glass for a first duration by immersing the glass into a molten first strengthening material at a first predetermined temperature; removing the strengthening shielding layer and the first strengthening material remaining on a surface of the glass; performing a second chemical strengthening treatment on the bendable region and the non-bendable region of the glass for a second duration by immersing the glass into a molten second strengthening material at a second predetermined temperature; and removing the second strengthening material remaining on the surface of the glass.

In some embodiments, performing n chemical strengthening treatments on the glass includes: performing a first chemical strengthening treatment on the bendable region and the non-bendable region of the glass for a first duration by immersing the glass into a molten first strengthening material at a first predetermined temperature; removing the first strengthening material remaining on a surface of the glass; providing a strengthening shielding layer that shields the bendable region of the glass, such that the bendable region is prevented from being chemically strengthened; performing a second chemical strengthening treatment on the non-bendable region of the glass for a second duration by immersing the glass into a molten second strengthening material at a second predetermined temperature; removing the strengthening shielding layer and the second strengthening material remaining on the surface of the glass; performing a third chemical strengthening treatment on the bendable region and the non-bendable region of the glass for a third duration by immersing the glass into a molten third strengthening material at a third predetermined temperature; and removing the third strengthening material remaining on the surface of the glass; wherein the first duration is less than the second duration, and the third duration is less than the first duration.

In some embodiments, forming the recess having the predetermined depth by thinning the selected region of the first plane of the glass substrate includes: providing a thinning shielding layer configured to shield the non-selected region of the glass substrate, such that the non-selected region is prevented from being etched; etching the selected region such that the glass substrate is thinned at the selected region by the predetermined depth and the recess is formed; and removing the thinning shielding layer.

In some embodiments, etching the selected region such that the glass substrate is thinned at the selected region by the predetermined depth and the recess is formed includes: etching an etching region within the selected region to a specified depth; increasing a width of the etching region by a predetermined value, determining the increased etching region as a new etching region, and etching the new etching region to the specified depth; and repeating the step of increasing the width of the etching region by the predetermined value until an etching depth is equal to the predetermined depth of the recess.

### BRIEF DESCRIPTION OF DRAWINGS

FIG. 1 is a schematic structural diagram of glass according to some embodiments of the present disclosure;

FIG. 2 is a flowchart of processing a recess in a method for manufacturing glass according to some embodiments of the present disclosure;

FIG. 3 is another flowchart of processing a recess in a method for manufacturing glass according to some embodiments of the present disclosure;

FIG. 4 is a flowchart of chemically strengthening glass in a method for manufacturing glass according to some embodiments of the present disclosure;

FIG. 5 is another flowchart of chemically strengthening glass in a method for manufacturing glass according to some embodiments of the present disclosure;

FIG. 6 is a schematic diagram of a stacking structure of a foldable display panel according to some embodiments of the present disclosure;

FIG. 7 is a schematic diagram of another stacking structure of a foldable display panel according to some embodiments of the present disclosure; and

FIG. 8 is a schematic diagram of yet another stacking structure of a foldable display panel according to some embodiments of the present disclosure.

Reference numerals and denotations thereof:

recess 1, first plane 2, second plane 3, bottom surface 11, first arcuate surface 12, second arcuate surface 13.

### DETAILED DESCRIPTION

The present disclosure is described in further detail with reference to the accompanying drawings, to clearly present the objects, technical solutions, and advantages of the present disclosure.

In recent years, to improve the impact strength, flexible glass has been used in a few foldable display screens, but the thickness of the flexible glass is below 50 μm, and the common thickness is 30 μm to ensure the bending performance. Because the thickness of the whole glass is thin, compared with the original organic material, the impact performance gain brought by the flexible glass is not obvious.

In addition to equal-thickness glass, manufacturers also develop unequal-thickness glass. Unequal-thickness glass has a recess region that can be bent and a flat region that cannot be bent but has a higher impact strength, also known as a non-bendable region. A thickness of the non-bendable region is greater than that of the bendable region, such that the non-bendable region has a better impact strength and a bending radius of the bendable region is smaller. However, because of a thickness difference of the unequal-thickness glass, during the chemical strengthening, a thicker region has less strengthening expansion and a thinner region has more strengthening expansion, and thus a transition region between the thick region and the thin region generates internal stresses due to the presence of dimensional difference. Consequently, the transition region is more susceptible to creases.

In response to this problem, most of the existing technologies reduces a depth of a stress layer of glass strengthening by shortening the strengthening duration. In this way, the strengthening expansion of the bendable region and the non-bendable region of the unequal-thickness glass is reduced, such that the dimensional difference between the bendable region and the non-bendable region is reduced, and thus the appearance of creases is improved. However, due to the reduction of the depth of the stress layer, the overall impact strength of the unequal-thickness glass decreases, and the bending performance of the bendable region also decreases.

Therefore, how to improve the appearance of creases while ensuring the impact strength of the glass is the technical problem that is urgently needed to be solved by those skilled in the art.

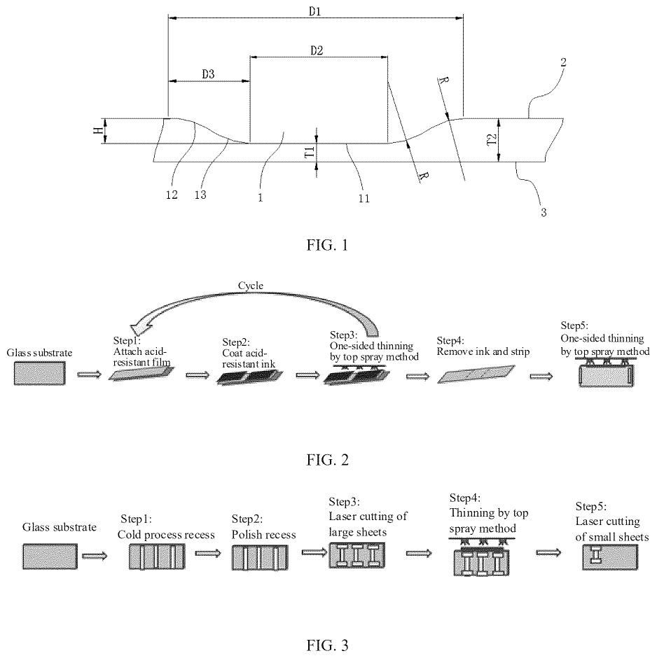

Glass for a foldable display panel provided by the present disclosure, as shown in FIG. 1, includes glass and a recess 1 formed in a first plane 2 of the glass. A surface, going away from the first plane 2, of the glass is a second plane 3. The recess 1 is disposed in a bendable region of the foldable display, and the recess 1 extends along a lengthwise direction of the bendable region and runs through the first plane 2. When the foldable display is bent, a region of the recess 1 is also bent. Because a distance between a bottom surface 11 of the recess 1 and the second plane 3 is smaller than a distance between the first plane 2 and the second plane 3, a smaller bending radius is achieved in a case where the glass is bent at the recess 1. A thickness of a region of the non-recess 1 of the glass is great, and thus the impact strength is high.

A thickness of the recess 1 region in the glass is less than the thickness of the non-recess 1 region. To make a gradual transition between the two regions, included angles between both side surfaces of the recess 1 and the first plane 2 are both greater than 90 degrees, such that a distance between the two side surfaces of the recess 1 gradually increases along a direction close to the first plane 2.

As shown in FIG. 1, the side surface of the recess 1 includes a first arcuate surface 12 and a second arcuate surface 13. The first arcuate surface 12 is connected to the first plane 2 and curved from the first plane 2 towards the bottom surface 11 of the recess 1. The second arcuate surface 13 is connected to the bottom surface 11 of the recess 1 and curved from the bottom surface 11 of the recess 1 towards the first plane 2. The first arcuate surface 12 and the second arcuate surface 13 are connected to each other.

In the embodiments, the recess 1 corresponding to the bendable region of the foldable display is formed in the glass, such that the thickness of the glass is reduced, and thus the glass has a smaller bending radius in the region of the recess 1, which satisfies the bending requirement of the foldable display. The side surface of the recess 1 includes the first arcuate surface 12 and the second arcuate surface 13. The transition between the bottom surface 11 of the recess 1 and the first plane 2 of the glass is achieved by the two arcuate surfaces, such that the thickness of the glass gradually increases from the bottom surface 11 of the recess 1 to the first plane, and thus the creasing problem due to the difference in expansion coefficients is improved. In addition, the smooth transition from the side surface of the recess 1 to the bottom surface 11 of the recess 1 and the first plane 2 further improves the creasing problem of the glass.

In some embodiments, at a junction between the first arcuate surface 12 and the first plane 2, the first plane 2 coincides with a tangent plane of the first arcuate surface 12 at that junction. At a junction between the second arcuate surface 13 and the bottom surface of the recess 1, the bottom surface 11 of the recess 1 coincides with a tangent plane of the second arcuate surface 13 at that junction. At a junction between the first arcuate surface 12 and the second arcuate surface 13, the tangent planes of the two arcuate surfaces coincide. Therefore, the first arcuate surface 12 and the second arcuate surface 13 also have a smooth transition. In some embodiments, the user may also provide a structure such as a transition plane between the first arcuate surface 12 and the second arcuate surface 13 as desired, such that a length of the side surface of the recess 1 is extended, and thus the length is adapted to a depth of the recess 1.

In some embodiments, the bottom surface 11 of the recess 1 is rectangular and parallel to the first plane 2, and a lengthwise direction of the bottom surface 11 of the recess 1 is a direction running through the first plane 2. In some embodiments, the bottom surface 11 of the recess 1 is not limited to the rectangular shape. The distance T1 between the bottom surface 11 of the recess 1 and the second plane 3 of the glass is greater than or equal to 30 μm and less than or equal to 50 μm. The depth H of the recess 1 is greater than or equal to 30 μm and less than or equal to 300 μm. Accordingly, the distance T2 between the second plane 3 and the first plane 2 of the glass is greater than or equal to 60 μm and less than or equal to 350 μm. The sum of the distance T1 between the bottom surface 11 of the recess 1 and the second plane 3 of the glass and the depth H of the recess 1 is equal to the distance T2 between the first plane 2 and the second plane 3 of the glass.

In some embodiments, a distance D2 between intersection lines of the bottom surface 11 of the recess 1 and the two side surfaces is greater than or equal to 20 mm and less than or equal to 30 mm. A distance D1 between two sides of a notch of the recess 1 is greater than or equal to 30 mm and less than or equal to 50 mm. A distance D3 between a side, close to the bottom surface of the recess 1, of an orthographic projection of the side surface of the recess 1 on the first plane 2 and a side, away from the bottom surface of the recess 1, of the orthographic projection of the side surface of the recess 1 on the first plane 2 is greater than or equal to 5 mm and less than or equal to 10 mm. The distance D3 is a width of the orthographic projection of the side surface of the recess 1 on the first plane 2.

In some embodiments, the two side surfaces of the recess 1 are symmetrical about a center line of the bottom surface 11 of the recess 1, and the sum of the distance D2 between the intersection lines of the bottom surface 11 of the recess 1 and the two side surfaces and the width D3 of the orthographic projection of the side surface of the recess 1 on the first plane 2 is equal to the distance D1 between the two sides of the notch of the recess 1. That is, D2+2×D3=D1. In some embodiments, the user may also provide the two side surfaces of the recess 1 to be asymmetrical, which is not limited herein.

In some embodiments, the first arcuate surface 12 and the second arcuate surface 13 are both circular arcuate surfaces, and the curvature radii R of cross sections of both the two surfaces are greater than or equal to 10 mm, and the user may also define the value of the curvature radius R as required, which is not limited herein.

In some embodiments, the distance D1 between the two sides of the notch of the recess 1, which is greater than or equal to 30 mm and less than or equal to 50 mm, simultaneously meets the needs of the teardrop-shaped bending and U-shaped bending of the foldable display. The depth H of the recess 1, which is greater than or equal to 30 μm and less than or equal to 300 μm, meets the requirements of different impact strength and bending performance. The side surface of the recess 1 transitions with the bottom surface 11 and the first plane 2 of the recess 1 through the circular arcuate surface. In this way, in one aspect, the difference in expansion rates caused by the thickness difference is reduced, and the creasing phenomenon caused by the difference in expansion rates is improved, in another aspect, the problem of light and shadow caused by coating organic materials on the glass surface in later period is avoided.

Additionally, the present application further provides a method for manufacturing glass, applicable to manufacturing the glass as described above. The method includes the following steps.

A recess 1 is formed by thinning a selected region in a first plane of a glass substrate, wherein the selected region corresponds to a bendable region of the foldable display, and a non-selected region in the first plane corresponds to a non-bendable region of the foldable display.

In the present disclosure, the material of the glass substrate is selected as desired. The structure of the recess 1 is referred to descriptions above. A predetermined depth of the glass substrate is thinned by etching, machining, and the like, such that the recess 1 is formed. A first plane of the glass substrate and the first plane 2 of the glass as described above are in the same plane, and thus both of them become the first plane.

Glass is formed by cutting the thinned glass substrate.

The glass substrate is cut according to a desired size of the foldable display, and after cutting, the glass is formed as previously described. The size of the glass is defined according to the needs of the user, which is not limited herein.

Impact strength of the glass is strengthened.

The impact strength of the glass is improved by strengthening the cut glass. The glass is strengthened by chemical strengthening. In the chemical strengthening process, potassium and sodium salts are mixed to form a strengthening material, then the material is heated to a molten state, and then the glass is submerged in the molten strengthening material for a predetermined period, to produce an ion exchange at a location where the strengthening material and the glass are in contact, and thus the strengthening of the glass is achieved. The user may also select the strengthening material or use other processes to strengthen the glass as needed, which is not limited herein.

In some embodiments, the recess 1 is first processed to form in the glass substrate, then the glass substrate is cut to form the glass, and then the glass is strengthened to improve the impact strength. The recess 1 has already been formed in the glass, and the recess 1 allows the thickness of the glass to be varied gradually as previously described, such that the problem of creases occurring during the strengthening process is improved.

The glass substrate is thinned by etching, and in some embodiments, the glass substrate is thinned by etching. Accordingly, the above step of forming the recess 1 having the predetermined depth by thinning the selected region of the first plane of the glass substrate is as shown FIG. 2. The step includes the following:

defining a thinning shielding layer configured to shield a non-selected region of the glass substrate, such that the non-selected region is prevented from being etched; and

during the etching process, using a mixed acid solution containing hydrofluoric acid to etch and thin the glass substrate. To prevent the acid mixture from damaging the non-selected region, the non-selected region need to be protected by arranging the thinning shielding layer prior to etching. The non-selected region typically includes a region of a first plane of the glass substrate other than the selected region and a third plane, away from the first plane, of the glass substrate. An acid-resistant film is used as the thinning shielding layer covering the third plane, and an acid-resistant ink is used as the thinning shielding layer covering the non-selected region of the first plane. The step of defining the thinning shielding layer includes step 1 in FIG. 2 of attaching the acid-resistant film to the third plane, and step 2 of applying the acid-resistant ink to the first plane of the glass substrate, such that the acid-resistant ink completely covers the non-selected region of the first plane. There are at least two non-selected regions in the first plane, and an etching region is disposed between two adjacent thinning shielding layers of the first surface. The etching region is disposed in the selected region. In addition, in a case where multiple etchings are required to form the recess 1, a distance between the two adjacent etching shielding layers formed in the step of defining the thinning shielding layers is less than a distance between the two non-selected regions, which allows a margin for multiple etching operations.

The selected region is etched such that the glass substrate is thinned at the selected region to the predetermined depth and the recess 1 is formed.

As shown in FIG. 2, step 3 employs a top spray method to thin the glass substrate on one side, such that the recess 1 is formed in the glass substrate. The top spray method is referred to the related art, which not repeated herein.

In some embodiments, the recess 1 is formed by multiple etching, and a width of each etching is gradually increased, and thus the recess 1 as described above is formed by etching. An included angle between a side surface of the recess 1 and the first plane is obtuse. The step of etching the selected region thus includes the following.

an etching region within the selected region is etched to a specified depth.

In the process of forming the recess 1 by multiple etching, the width of the etching region is typically less than the width of the selected region. The width of the etching region is increased with each etching until it is equal to the width of the selected region, and likewise, the specified depth is typically less than the predetermined depth of the recess 1.

The width of the etching region is increased by a predetermined value. The increased etching region is determined as a new etching region, and the specified depth is etched in the new etching region.

After the initial etching is completed, the thinning shielding layer needs to be removed, and then the acid-resistant ink is reapplied and the acid-resistant film is attached. The steps of step 1, step 2, and step 3 are repeated in a loop as shown in FIG. 2. When repeating step2, the distance between two adjacent pieces of anti-acid ink needs to be increased, and thus the width of the etching region is increased by the predetermined value, which is used as the new etching region. Then, step3 is repeated to etch the new etching region to the specified depth.

The step of increasing the width of the etching region by the predetermined value is repeated until the etching depth is equal to the predetermined depth of the recess 1.

After several repetitions of the step of defining a new etching region, the width of the etching region is equal to the width of the selected region. After the etching region is etched to the specified depth, the etching depth is equal to the predetermined depth of the recess 1. In some specific embodiments of the present application, the specified depth is 15 μm, the predetermined value for increasing the width of the etching region is 2 mm, the predetermined depth of the recess 1 is a positive integer multiple of 15 μm, and the width of the recess 1 is a positive integer multiple of 2 mm. Thus, the selected region is made to form the shape of the recess 1 after several etchings. Of course, the specific values of the specified depth and the predetermined value are defined as desired, and the specified depths and the predetermined values for the multiple etching are different, which are not limited herein.

The thinning shielding layer is removed.

As shown in FIG. 2, after the recess 1 reaches the specified depth, in step 4, the acid-resistant ink is removed, the acid-resistant film is stripped, and the processing of the recess 1 is completed.

In some embodiments, to ensure the processing accuracy, the thickness of the glass substrate is typically greater than the thickness of the processed and formed glass to allow for a margin for the manufacturing process. Therefore, as shown in FIG. 2, after the recess 1 is manufactured, the glass substrate needs to be further manufactured in step 5, such that the glass substrate is thinned as a whole until the thickness of the non-selected region reaches a target thickness. Specifically, the overall thinning of the glass substrate is performed by the top spray method. A mixed acid solution is spared to the third plane of the glass substrate, such that the thickness of the glass substrate is thinned as a whole, and after the thinning process, a second plane is formed on a side, away from the first plane, of the glass substrate, and the second plane corresponds to the second plane of the glass.

The embodiments form the recess 1 by thinning the glass substrate by multiple etching. The width of the etching region is increased basis of the previous one before each etching, ultimately resulting in the formation of the recess 1 in the structure as described above.

The glass substrate is thinned in other ways, and in some embodiments, the glass substrate is thinned by machining. Thus, step S100 includes the following.

The selected region is machined, such that the glass substrate is thinned in the selected region to form the recess 1.

In some embodiments, as shown in FIG. 3, the machining is performed using a computer numerical control (CNC) to cold process the glass substrate, and the depth and shape of the recess 1 is acquired after the CNC cold process in step 1. Of course, the user may also use other machine tools to process the glass substrate to acquire the recess 1, which is not limited herein.

A machined texture is removed by polishing an inner surface of the recess 1.

After CNC cold machining, the machined texture remains on the surface of the glass substrate, which affects normal use, and thus the surface of the recess 1 needs to be polished. As shown in FIG. 3, the recess 1 is polished in step 2.

The machining is usually applied to the processing of the glass substrate with a larger size, and thus as shown in FIG. 3, after the polishing is completed, it also includes step 3 to cut the large-sized glass substrate into a small-sized glass substrate to meet the subsequent processing requirements. The cutting process is referred to as step S200. Of course, the user may also apply the machining process to the small-sized glass substrate, which is not limited herein.

A margin in the glass substrate is also required during machining the recess 1, such that after cutting the large-sized glass substrate into the small-sized glass substrate in FIG. 3, the small-sized glass substrate is also thinned in step 4. The thinning process is performed using the top spray method, and the thinning process is referred to the embodiments described above, which is not repeated herein.

After the thinning is completed, step 5 is performed to cut the small-sized glass substrate to form the glass as described above. The cutting process is referred to as step S200, which is not limited herein.

In some embodiments, the recess 1 is processed in the surface of the larger-sized glass substrate by CNC cold process, which is suitable for mass production due to higher processing efficiency and lower material consumption compared to etching the recess 1.

The cut glass needs to be strengthened to improve its impact strength. There is the recess 1 in the glass body that corresponds to the bendable region of the foldable display, the rest of the glass body corresponds to the non-bendable region of the foldable display, and the bendable region and the non-bendable region have different requirements for impact strength, such that the bendable region and the non-bendable region need to be strengthened in a target manner. Thus, strengthening the impact strength of the glass includes the following.

The predetermined depth of the recess 1 and a depth threshold are compared.

In a case where the predetermined depth is less than or equal to the depth threshold, a single chemical strengthening treatment is performed on the bendable region and the non-bendable region of the first plane 2 of the glass.

In a case where the predetermined depth is greater than the depth threshold, n chemical strengthening treatments are performed on the glass, wherein n is a positive integer greater than or equal to 2.

Specifically, the user determines the strengthening scheme based on the predetermined depth of the recess 1. In the case where the predetermined depth of the recess 1 is small, a single chemical strengthening treatment is performed on the glass, and the strengthening process increases the impact strength of both the bendable and non-bendable regions. As described above, the recess 1 region is the bendable region of the glass and the non-recess 1 region is the non-bendable region of the glass. In the case where the depth of the recess 1 is large, n chemical strengthening treatments are performed on the recess 1. The present disclosure determines whether to perform more than two chemical strengthening treatments on the glass by comparing the predetermined depth of the recess 1 and the depth threshold, and the user selects the number of chemical strengthening treatments performed on the glass in other ways, which is not limited herein. In some specific embodiments of the present application, the depth threshold is 70 μm. In some embodiments, the user also defines the depth threshold according to the need, which is not limited herein.

Further, an edge of the glass acquired after cutting the glass substrate is sharp, which does not facilitate subsequent processing. Thus, the edge of the glass needs to be passivated. The glass is ground and passivated by machining, or by acid etching, and the passivation is referred to the related art, which is not limited herein.

In some embodiments, the glass has different thicknesses in the bendable and non-bendable regions, and thus the glass needs to be matched with different depths of strengthening layers. The bendable region is thinner and needs to be matched with a shallower depth of strengthening layer, and the non-bendable region is thicker and needs to be matched with a deeper depth of strengthening layer. As a result, the number of the strengthening treatments performed on the non-bendable region is greater than that of the bendable region. Specifically, a treatments of the n chemical strengthening treatments are performed on both the non-bendable region of the first plane 2 and an inner surface of the recess 1, wherein a is a positive integer greater than or equal to 1 and less than or equal to n−1. The remaining n−a treatments are performed only on the non-bendable region of the first plane 2. As a result, the number of the strengthening treatments performed on the non-bendable region is greater than that of the bendable region, such that the thickness of the strengthening layer in the non-bendable region is greater than the thickness of the strengthening layer in the bendable region.

The present disclosure provides some specific embodiments as shown in FIG. 4 in which two chemical strengthening treatments are performed on the glass, which include the following.

A strengthening shielding layer is provided to shield the bendable region of the glass.

The strengthening shielding layer is configured to shield the bendable region from strengthening, as shown in step 1 of FIG. 4. The strengthening shielding layer is made of high temperature ink or coating, and the coating material is made of ITO, CuO, ZnO, or the like. Of course, the user also chooses other materials to form the strengthening shielding layer according to the needs, which are not limited herein.

At a first predetermined temperature, a first chemical strengthening treatment is performed on of the glass by a first strengthening material for a first duration.

As shown in step 2 of FIG. 4, the first strengthening material is typically a mixture of potassium and sodium salts, the first strengthening material is in a molten state at the first predetermined temperature, and the glass is submerged in the first strengthening material for the first duration.

The strengthening shielding layer and the first strengthening material remaining on a surface of the glass are removed.

After the first strengthening is completed, the strengthening shielding layer is removed, as shown in step 3 3 of FIG. 4. The first strengthening material is removed by washing, and additionally, the glass is cleaned by ultrasonic waves to sufficiently remove the strengthening material. The second strengthening is then performed.

At a second predetermined temperature, a second chemical strengthening treatment is performed on the glass for a second duration by a second strengthening material.

The second strengthening material remaining on the surface of the glass is removed.

As shown in step 4 of FIG. 4, the second strengthening is performed on both the bendable and non-bendable regions of the glass. The second strengthening material is also a mixture of potassium salt and sodium salts, and the ratios of sodium salts to potassium salts are different in the two strengthening treatments. The second strengthening material is in a molten state at the second predetermined temperature, and the glass is submerged in the second strengthening material for the second predetermined duration. After the second chemical strengthening is completed, the glass is cleaned and the second strengthening material is removed. The user defines parameters such as the first predetermined temperature, the first duration, the second predetermined temperature, and the second duration of the strengthening treatment as desired, which are not limited herein.

In some specific embodiments, two chemical strengthening treatments are performed on the glass. The recess 1 is shielded before the first chemical strengthening treatment, such that the first chemical strengthening treatment only strengthens the bendable region of the glass. The strengthening shielding layer is removed before the second chemical strengthening treatment, such that the second chemical strengthening treatment improves the impact strength of the glass in both the bendable region and the non-bendable region. Due to the different ranges of the two strengthening, a shallower depth of the stress layer is formed in the bendable region and a deeper depth of the stress layer is formed in the non-bendable region, and thus the performance in the bendable and non-bendable regions is better.

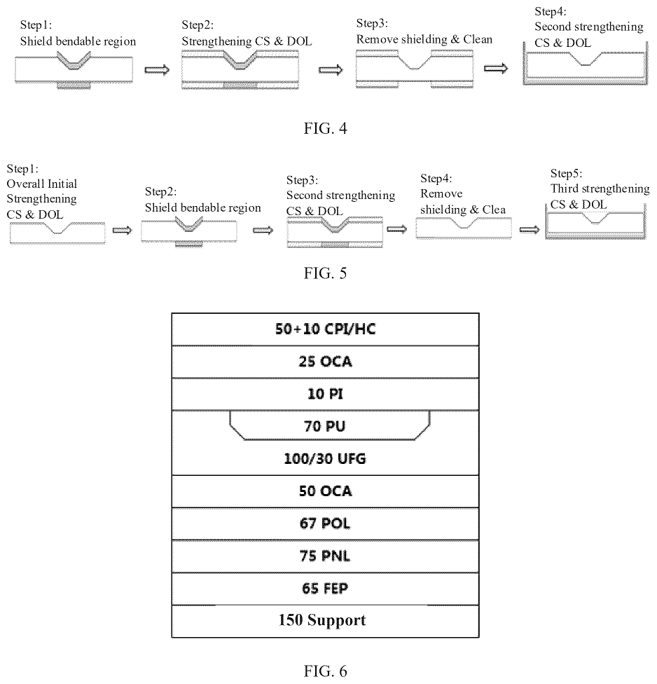

The present disclosure provides other specific embodiments in which three chemical strengthening treatments are performed on the glass, as shown in FIG. 5, including the following.

A first chemical strengthening treatment is performed on the glass by a first strengthening material at a first predetermined temperature for a first duration.

The first strengthening material remaining on a surface of the glass is removed.

The first chemical strengthening treatment is used to strengthen the glass as a whole for a short duration, as shown in step 1 in FIG. 5. The first strengthening treatment improves the strength of the glass such that the glass is less likely to crease during the subsequent strengthening process. After the first chemical strengthening treatment is completed, the glass is cleaned to remove the first strengthening material. The process of the first chemical strengthening treatment is referred to the embodiments described above and is not repeated here.

A strengthening shielding layer is provided to shield the bendable region of the glass, such that the bendable region is prevented from being chemically strengthened.

A second chemical strengthening treatment is performed on the glass by a second strengthening material at a second predetermined temperature for a second duration.

The second chemical strengthening treatment of the glass is a shielding strengthening. As shown in step 2 in FIG. 5, the strengthening shielding layer shields the bendable region, and the shielding method is referred to the previous embodiments. As shown in step3 in FIG. 5, the second chemical strengthening treatment is only used to improve the impact strength of the non-bendable region, and the strengthening process deepens the depth of the stress layer in the non-bendable region. The second chemical strengthening treatment is referred to the previous embodiments and is not repeated herein.

The strengthening shielding layer and the second strengthening material remaining on the surface of the glass are removed.

After the first strengthening treatment is completed, the strengthening shielding layer is removed and the glass is cleaned to remove the first strengthening material, such that the strengthening shielding layer and the second strengthening material are prevented from affecting the subsequent strengthening.

At a third predetermined temperature, a third chemical strengthening treatment is performed on the glass for a third duration by a third strengthening material.

The third strengthening material remaining on the surface of the glass is removed.

The third chemical strengthening treatment is used to strengthen the glass as a whole. Thus, as shown in step 4 in FIG. 5, the strengthening shielding layer needs to be removed and the glass is cleaned to avoid the residual shielding material and the second strengthening material from affecting the subsequent strengthening of the glass. Subsequently, the glass is strengthened as a whole with pure potassium salt as the third strengthening material, and the surface compressed stress of the glass is increased by strengthening with pure potassium salt. In some embodiments, the first duration is smaller than the second duration, and the third duration is smaller than the first duration. Of course, the user also defines the durations of the three chemical strengthening treatments and selects the third strengthening material according to the need, which is not limited herein.

In some specific embodiments, the glass as a whole is strengthened once for a short period before shielding strengthening, which improves the strength of the whole glass. As the glass is strengthened, the bendable region has sufficient strength to balance the stresses generated during the strengthening process of the non-bendable region during the second chemical strengthening treatment, which reduces the creases of the glass that occur during the second strengthening treatment. Finally, the overall strengthening of the glass is performed with potassium salt as the third strengthening material, such that the surface compressed stress of the glass is increased, and thus the strength of the glass is further increased.

In some embodiments, the surface of the strengthened glass has potassium ions and/or sodium ions coated to at least some regions.

In some embodiments, after the glass is strengthened, a colorless transparent material is provided to fill the recess 1 of the glass as a transparent filling layer. A selected range of refractive index of the colorless transparent material is greater than or equal to 1.41 and less than or equal to 1.61. The filling further improves the effect of creases on the appearance of the foldable display. Of course, the refractive index of the colorless transparent material is not limited to this.

The present disclosure tests the correspondence between the strengthening conditions and the strengthening effects by experiments, as listed in Table 1.

TABLE 1
Comparison of strengthening conditions and strengthening effects

| | Ratio of strengthening | | Strengthening | | Target stress | | Target stress in | |
|---|---|---|---|---|---|---|---|---|
| | salt | | parameter | | in bendable | | non-bendable | |
| | | Ratio of | | | region | | region | |
| Process | Strengthening | sodium to | Temp | Duration | CS | DOL | CS | DOL |
| category | category | potassium | (° C) | (min) | (MPa) | (μm) | (MPa) | (μm) |
| One | First | 1:8~1:4 | 350~380 | 15~30 | 300~400 | 5~8 | 300~400 | 5 ~8 |
| strengthening | strengthening | | | | | | | |
| treatment | | | | | | | | |
| Two | First | 1:8~1:4 | 350~380 | 10~20 | shielding | | 300~400 | 3 ~ 5 |
| strengthening | strengthening | | | | | | | |
| treatments | Second | 1:8~1:4 | 350~380 | 15~30 | 300~400 | 6~9 | 300~400 | 8~11 |
| | strengthening | | | | | | | |
| Three | First | 1:8~1:4 | 350~380 | 5~10 | 300~400 | 2~3 | 300~400 | 2~3 |
| strengthening | strengthening | | | | | | | |
| treatments | Second | 1:8~1:4 | 350~380 | 15~30 | shielding | | 300~400 | 8~10 |
| | strengthening | | | | | | | |
| | Third | Pure | 350~380 | 2~5 | 500~600 | 5~7 | 500~600 | 9~11 |
| | strengthening | potassium | | | | | | |

In Table 1, CS is the surface compressed stress, and DOL is the thickness of the stress layer. One strengthening treatment, two strengthening treatments, and three strengthening treatments in the process category represent the total number of chemical strengthening treatments performed on the glass. First strengthening, second strengthening, and third strengthening in the strengthening category represent the first strengthening treatment, the second strengthening treatment, and the third strengthening treatment, respectively. For example, the process category is three strengthening treatments, and the strengthening category is second strengthening, which means that a total of three chemical strengthening treatments need to be performed on the glass, and the act is the second strengthening treatment. The optional range of the ratio of sodium to potassium of the second strengthening material is greater than or equal to 1:8 and less than or equal to 1:4. The optional range of the second predetermined temperature is greater than or equal to 350 degrees Celsius and less than or equal to 380 degrees Celsius. The optional range of the second duration is greater than or equal to 15 minutes and less than or equal to 30 minutes. The strengthening process shields the bendable region and thus does not affect the surface compressed stress in the bendable region or increase the thickness of the stress layer in the bendable region. The surface compressed stress in the non-bendable region after strengthening is in a range of greater than 300 MPa and less than 400 MPa, and the thickness of the stress layer is in a range of greater than 8 μm and less than 10 μm. The meanings of the other rows in Table 1 are similar and are not repeated here. From the test data in Table 1, the strengthening method provided in the present disclosure effectively improves the impact strength of the glass. The user selects the strengthening conditions based on the data in Table 1, and of course, the strengthening conditions are not limited to the embodiments illustrated in Table 1.

Further, to verify the strengthening effect, the present disclosure also performs several performance test experiments to test the strengthening effect of different processing methods on the glass.

In the test, 500 μm glass made of aluminum-silicon is used as the glass substrate, and CNC cold machining is used to thin the glass substrate to form the recess 1. After the recess 1 is machined and formed, the glass substrate is polished by a polishing machine to remove the knife lines produced by the CNC machining, and the amount of polishing is about 50 μm. After polishing, the glass substrate is thinned by chemical etching. After thinning, the glass substrate is cut by laser into a rectangular glass of 145×73 mm, and the recess 1 is arranged along the widthwise direction of the glass and disposed in the middle of the lengthwise direction of the glass. After the cutting is completed, the plurality of pieces of glass are stacked, and every two adjacent pieces of glass are bonded and fixed to each other. The process of stacking and fixing is referred to the way of dispensing glue to stack the pieces in the related art. After the fixing is completed, an acid-resistant film is adhered to an exposed plane of the stacked glass, and then the fixed plurality of pieces of glass is immersed into a passivation acid solution for edge passivation. The passivation acid solution contains hydrofluoric acid, which corrodes the edge of the glass and eliminates the corners of the glass edge, serving as a passivation role. The specific composition of the passivation acid solution is found in the related art.

After the passivation, the stacked glass is separated and the glass is chemically strengthened according to different processing parameters. A variety of glasses with different structures are selected for testing and tested under different strengthening parameters. The parameters to be acquired for the test include the target stress in the bendable region, the target stress in the non-bendable region, the minimum bending radius to satisfy 200,000 times of dynamic bending without creasing, and the pen drop impact test of the screen. The processing parameters and corresponding performance test results are listed in Table 2.

The dimensions T1, T2, D1, D2, and D3 in Table 2 are referred to the above texts and FIG. 1, and the meanings of one strengthening treatment, two strengthening treatments, three strengthening treatments, and first strengthening, second strengthening, and third strengthening in Table 2 are referred to Table 1, which are not limited herein.

Three groups of tests are performed for each of the one strengthening treatment, two strengthening treatments, three strengthening treatments in Table 2, and according to the test results, it can be seen that the minimum bending radii of 200,000 times of dynamic bending without creases in the nine groups of tests are less than or equal to 1.5 mm, and thus the bending performance is good. A pen impact test is used to test the impact strength of the glass, and the requirement staying the standard is that the glass does not break. The test uses a biro with a mass of 12g and a tip diameter of 0.5 mm as the test equipment. In the test process, a marble plate is provided below the glass as a support, a polyethylene terephthalate polyester resin (PTT) cushion layer of 75 μm is provided between the glass and the marble plate. The glass and the PET cushion layer are fixed and bonded by an optical adhesive of 50 μm. A colorless polyimide layer of 80 μm is covered above the glass. The glass and the colorless polyimide layer are fixed and bonded by an optical adhesive of 50 μm. During the testing process, several points on the glass are subjected to pen impacts, and the height of the glass subjected to pen impacts is the minimum height of all test points subjected to pen impacts.

TABLE 2
Comparison of Processing Parameters and Performance Test Results

| | | | | | | Ratio of | | | |
|---|---|---|---|---|---|---|---|---|---|
| | | | | | | strengthening | | Strength- | |
| | | | | | | salt | | ening | |
| Pro- | Glass Structure | | | | | Strength- | Ratio of | parameter | |
| cessing | T1 | T2 | D1 | D2 | D3 | ening | sodium to | Tem | Duration |
| category | (μm) | (μm) | (mm) | (mm) | (mm) | category | potassium | (° C.) | (min) |
| One | 30 | 70 | 30 | 20 | 5 | First | 1:6 | 360 | 20 |
| strength- | | | | | | strength- | | | |
| ening | | | | | | ening | | | |
| treat- | 30 | 100 | 40 | 26 | 5 | First | 1:6 | 361 | 15 |
| ment | | | | | | strength- | | | |
| | | | | | | ening | | | |
| | 50 | 100 | 40 | 26 | 5 | First | 1:6 | 360 | 30 |
| | | | | | | strength- | | | |
| | | | | | | ening | | | |
| Two | 30 | 100 | 40 | 26 | 7 | First | 1:6 | 360 | 15 |
| strength- | | | | | | strength- | | | |
| ening | | | | | | ning | | | |
| treat- | | | | | | Second | 1:6 | 360 | 20 |
| ments | | | | | | strength- | | | |
| | | | | | | ening | | | |
| | 30 | 120 | 40 | 26 | 7 | First | 1:6 | 360 | 20 |
| | | | | | | strength- | | | |
| | | | | | | ening | | | |
| | | | | | | Second | 1:6 | 360 | 20 |
| | | | | | | strength- | | | |
| | | | | | | ening | | | |
| | 50 | 170 | 40 | 26 | 7 | First | 1:6 | 360 | 25 |
| | | | | | | strength- | | | |
| | | | | | | ening | | | |
| | | | | | | Second | 1:6 | 360 | 30 |
| | | | | | | strength- | | | |
| | | | | | | ening | | | |
| Three | 30 | 100 | 40 | 26 | 7 | First | 1:6 | 360 | 10 |
| strength- | | | | | | strength- | | | |
| ening | | | | | | ning | | | |
| treat- | | | | | | Second | 1:6 | 360 | 20 |
| ments | | | | | | strength- | | | |
| | | | | | | ening | | | |
| | | | | | | Third | 1:6 | 360 | 2 |
| | | | | | | strength- | | | |
| | | | | | | ening | | | |
| | 30 | 120 | 40 | 26 | 7 | First | 1:6 | 360 | 10 |
| | | | | | | strength- | | | |
| | | | | | | ening | | | |
| | | | | | | Second | 1:6 | 360 | 25 |
| | | | | | | strength- | | | |
| | | | | | | ening | | | |
| | | | | | | Third | Pure | 360 | 2 |
| | | | | | | strength- | potassium | | |
| | | | | | | ening | | | |
| | 50 | 170 | 40 | 26 | 7 | First | 1:6 | 360 | 10 |
| | | | | | | strength- | | | |
| | | | | | | ening | | | |
| | | | | | | Second | 1:6 | 360 | 30 |
| | | | | | | strength- | | | |
| | | | | | | ening | | | |
| | | | | | | Third | Pure | 360 | 2 |
| | | | | | | strength- | potassium | | |
| | | | | | | ening | | | |
| | | | Target | | | | | | |
| | | | stress in | | Target stress in | | | Assy pen | |
| | | | bendable | | non-bendable | | 200k | impact (cm) | |
| | | Pro- | region | | region | | times | Bend- | Non- |
| | | cessing | CS | DOL | dynamic | able | dynamic | able | bendable |
| | | category | (MPa) | (μm) | bending | region | bending | region | region |
| | | One | 368 | 6.3 | 366 | 6.4 | R1 | 17 | 24 |
| | | strength- | | | | | | | |
| | | ening | | | | | | | |
| | | treat- | 355 | 5.5 | 359 | 5.4 | R1 | 16.5 | 28 |
| | | ment | | | | | | | |
| | | | 374 | 7.6 | 377 | 7.9 | R1.5 | 23.5 | 32.5 |
| | | Two | Shielding | | 359 | 3.5 | R1 | 16.5 | 37 |
| | | strength- | | | | | | | |
| | | ening | | | | | | | |
| | | treat- | 369 | 5.6 | 379 | 8.6 | | | |
| | | ment | | | | | | | |
| | | | Shielding | | 384 | 5.7 | R1 | 17.5 | 42.5 |
| | | | 379 | 5.8 | 388 | 11 | | | |
| | | | Shielding | | 369 | 7.4 | R1.5 | 23 | 52 |
| | | | 368 | 7.2 | 385 | 15.6 | | | |
| | | Three | 377 | 2.5 | 369 | 2.4 | R1 | 19.5 | 41.5 |
| | | strength- | | | | | | | |
| | | ening | | | | | | | |
| | | treat- | Shielding | | 368 | 7.8 | | | |
| | | ments | | | | | | | |
| | | | 565 | 5.5 | 578 | 9.8 | | | |
| | | | 379 | 2.8 | 381 | 2.7 | R1 | 20 | 47.5 |
| | | | Shielding | | 388 | 9.6 | | | |
| | | | 577 | 5.4 | 569 | 12.1 | | | |
| | | | 369 | 2.6 | 381 | 2.4 | R1.5 | 31 | 63 |
| | | | Shielding | | 388 | 10.6 | | | |
| | | | 571 | 5.8 | 601 | 13.9 | | | |

During the test, the biros is dropped from a height of 0.5 cm from the glass to impact the glass, then the height of the subsequent drop is increased by 0.5 cm unit, and the height is recorded at the time the glass is broken after impact. The test results are listed in Table 2. From the data recorded in Table 2, it can be seen that the glass acquired by processing by the manufacturing method provided in the present disclosure has a good impact strength.

The present disclosure also provides a foldable display including the glass described above. The foldable display further includes a transparent filling layer, and the transparent filling layer employs a colorless transparent material to fill the recess 1 of the glass to be flushed with the first plane 2. The colorless transparent material has a selectable range of refractive index greater than or equal to 1.41 and less than or equal to 1.61. Specifically, the colorless transparent material is polyurethane, polyimide, or a mixture of the two. The filling further improves the effect of creases on the appearance of the foldable display. Of course, other colorless transparent materials are selected by the user and are not limited herein.

In some embodiments, the foldable display includes a display panel, a cover layer, and a heat dissipation support layer. The cover layer covers the display panel and serves to protect the display panel. The heat dissipation support layer is used to support the display panel and promote heat dissipation from the display panel. The glass is disposed in the cover layer. The present application provides three embodiments of the stacking structure of the foldable display. Of course, the user also adopts other stacking structures as desired, which is not limited herein.

### Embodiment I

As shown in FIG. 6, the glass UFG includes glass of 100 μm and a recess 1 of a 70 μm deep. The recess 1 is filled by a polyurethane PU, and a first plane 2 of the glass UFG is covered with a polyimide layer PI. A first optical adhesive layer OCA is covered on a side of the polyimide layer PI away from the glass UFG, and a first optical adhesive layer OCA is covered on a side of the first optical adhesive layer OCA away from the glass UFG. The colorless polyimide layer CPI also has a strengthening layer HC. A second plane 3 of the glass is covered with a second optical adhesive layer OCA. The second optical adhesive layer OCA is covered with a polarizer POL on a side away from the glass UFG. The polarizer POL is covered with a display panel PNL on a side away from the second optical adhesive layer POL. A side, away from the polarizer POL, of the display panel PNL is covered with an FEP, and a side, away from the display panel PNL of the FEP, is provided with a support. The structure of the support is referred to the related art.

In some embodiments, the colorless polyimide layer CPI, the first optical adhesive layer OCA, the polyimide layer PI, the glass UFG, and the second optical adhesive layer OCA form a cover layer, and the FEP and the support form a heat dissipation support layer. The numerals in FIG. 6 are the thicknesses of the layers in microns. The 50+10 CPI/HC in FIG. 6 indicates that the colorless polyimide layer CPI of 50 μm has a 10 μm strengthening layer HC. The user defines the thickness of each layer and the depth of the recess 1 as desired, which are not limited herein.

### Embodiment 2

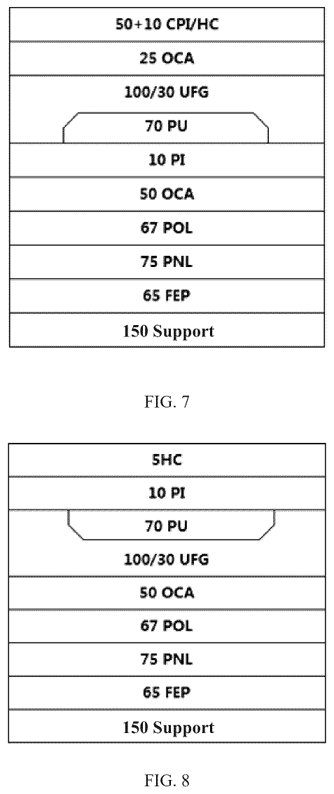

As shown in FIG. 7, the glass UFG includes a 100 μm glass body and a 70 μm deep recess 1, and the recess 1 is filled by polyurethane PU. The first plane 2 of the glass UFG is close to the display panel PNL, and a first plane 2 of the glass UFG is covered with a polyimide layer PI. The polyimide layer PI is covered with a second optical adhesive layer OCA on a side away from the glass UFG, the second optical adhesive layer OCA is covered with a polarizer POL on a side away from the polyimide layer PI, and the polarizer POL is affixed to the display panel PNL on a side away from the second optical adhesive layer OCA. The display panel PNL is covered with an FEP on a side away from the polarizer POL, and the FEP is provided with a support on a side away from the display panel PNL. A second plane 3 of the glass UFG is covered with a first optical adhesive layer OCA, the first optical adhesive layer OCA is covered with a colorless polyimide layer CPI on a side away from the glass, and the colorless polyimide layer CPI also has a strengthening layer HC. The structure of the support is referred to the related art, which is not repeated herein.

In some embodiments, the colorless polyimide layer CPI, the first optical adhesive layer OCA, the glass UFG, the polyimide layer PI, and the second optical adhesive layer OCA form a cover layer, and the FEP and the support form a heat dissipation support layer. The numerals in FIG. 7 are the thicknesses of the layers in microns. The 50+10 CPI/HC in FIG. 7 indicates that the 50 μm colorless polyimide layer CPI has a 10 μm strengthening layer HC. The user defines the thickness of each layer as well as the depth of the recess 1 as desired, which are not limited herein.

### Embodiment 3

As shown in FIG. 8, a first plane 2 of the glass UFG is covered with a polyimide layer PI, the polyimide layer PI is covered with a strengthening layer HC on a side away from the glass UFG, the glass UFG is covered with an optical adhesive layer OCA on a side away from the polyimide layer PI, a polarizer POL is covered with a second optical adhesive layer OCA on a side away from the glass UFG, and the polarizer POL is affixed to the display panel PNL on a side away from the second optical adhesive layer OCA. The display panel PNL is covered with an FEP on a side away from the polarizer POL, and the FEP is provided with a support on a side away from the display panel PNL. The structure of the support is referred to the related art and is not repeated herein.

In some embodiments, the strengthening layer HC, the polyimide layer PI, the glass UFG, and the optical adhesive layer OCA form a cover layer, and the FEP and the support form a heat dissipation support layer. The numerals in FIG. 8 indicate the thickness of each layer in microns. The user defines the thickness of each layer and the depth of the recess 1 as desired, which are not limited herein.

The present application also performs a falling pen impact test for the above three embodiments, and the test method of the falling pen impact test is as described in the previous embodiments. The strength of the foldable display screen is tested by placing the foldable display screen on a marble plate during the test, which is repeated herein. The test results are listed in Table 3. In addition, the pen impact test also tests the surface hardness of the stacked structure, and the surface hardness data are acquired by recording a depth of the recess in the colorless polyimide layer CPI or the strengthening layer HC of the foldable display in the pen impact test.

TABLE 3
Strength test table for stacked structures

| | | | | | Surface | |
|---|---|---|---|---|---|---|
| | Dynamic | | Pen falling | | hardness | |
| | bending | Depth | impact (cm) | | | Non- |
| | of 200k | of | | Non- | Bend- | bend- |
| Category | times | crease | Bendable | bendable | able | able |
| Performance | (mm) | (μm) | region | region | region | region |
| Embodiment | R1.5 | 218 | 8.5 | 14 | HB | 2H |
| I | | | | | | |
| Embodiment | R1.5 | 258 | 6.5 | 12 | 1H | 3H |
| 2 | | | | | | |
| Embodiment | R1.5 | 261 | 4.5 | 9.5 | 2H | 4H |
| 3 | | | | | | |

From the test results in Table 3, it can be seen that the bending radii of all three stacked structures all reach 1.5 mm, and the depths of the creases are all less than 300 μm, such that the foldable performance of the three stacked structures is excellent. The test results of surface hardness recorded in Table 3 are the Brinell hardness of the foldable display. Based on the test results in Table 3, it can be seen that the foldable display of Embodiment 1 has excellent impact strength, the foldable display of Embodiment 2 has both better impact strength and hardness, and the foldable display of Embodiment 3 has excellent surface hardness.

It should be understood that the above embodiments are merely exemplary embodiments to illustrate the principles of the present disclosure. However, the present disclosure is not limited thereto. For those skilled in the art, various variations and improvements may be made without departing from the spirit and substance of the present disclosure, which is also regarded as the scope of protection of the present disclosure.

1. A foldable display screen, comprising: glass, wherein the glass comprises a recess formed in a first plane of the glass; wherein
the recess is disposed in a bendable region of the foldable display screen, the recess extends in a lengthwise direction of the bendable region and runs through the first plane, and a distance between two side surfaces of the recess gradually increases along a direction close to the first plane;
wherein each of the side surfaces of the recess comprises a first arcuate surface and a second arcuate surface, wherein the first arcuate surface is connected to the first plane and curved towards a bottom surface of the recess, the second arcuate surface is connected to the bottom surface of the recess and curved towards the first plane, and the first arcuate surface is connected to the second arcuate surface.

2. The foldable display screen according to claim 1, wherein the bottom surface of the recess is parallel to the first plane, and a distance between the bottom surface of the recess and a second plane, away from the first plane, of the glass is greater than or equal to 30 μm and less than or equal to 50 μm.

3. The foldable display screen according to claim 1, wherein a distance between a side edge, close to the bottom surface of the recess, of an orthographic projection of the side surface of the recess on the first plane and a side edge, away from the bottom surface of the recess, of the orthographic projection of the side surface of the recess on the first plane is greater than or equal to 5 mm and less than or equal to 10 mm.

4. The foldable display screen according to claim 1, wherein the first arcuate surface and the second arcuate surface are both circular arcuate surfaces, and curvature radii of cross-sections of the two arcuate surfaces are both greater than or equal to 10 mm.

5. The foldable display screen according to claim 1, further comprising: a transparent filling layer configured to fill the recess, wherein a refractive index of the transparent filling layer is greater than or equal to 1.41 and less than or equal to 1.61.

6. The foldable display screen according to claim 5, further comprising: a display panel, a cover layer, and a heat dissipation support layer, wherein the cover layer is configured to cover and protect the display panel, and the glass is disposed in the cover layer.

7. The foldable display screen according to claim 5, wherein a surface of the glass is coated with potassium ions and/or sodium ions.

8. A method for manufacturing glass, applicable to manufacturing the glass in the foldable display screen as defined in claim 1, the method comprising:
forming a recess having a predetermined depth by thinning a selected region in a first plane of a glass substrate, wherein the selected region corresponds to a bendable region of the foldable display screen, and a non-selected region in the first plane corresponds to a non-bendable region of the foldable display screen;
forming the glass by cutting the thinned glass substrate; and
strengthening an impact strength of the glass.

9. The method according to claim 8, wherein strengthening the impact strength of the glass comprises:
comparing the predetermined depth of the recess with a depth threshold; and
in a case where the predetermined depth is less than or equal to the depth threshold, performing a single chemical strengthening treatment on the non-bendable region and the bendable region of the glass; or
in a case where the predetermined depth is greater than the depth threshold, performing n chemical strengthening treatments on the glass, wherein n is a positive integer greater than or equal to 2.

10. The method according to claim 9, wherein
a chemical strengthening treatments in the n chemical strengthening treatments are performed on both the non-bendable region and the bendable region of the glass, wherein a is a positive integer greater than or equal to 1 and less than or equal to n−1; and
n−a chemical strengthening treatments in the n chemical strengthening treatments are performed only on the non-bendable region in the first plane, such that a thickness of a strengthening layer in the non-bendable region is greater than a thickness of a strengthening layer in the bendable region.

11. The method according to claim 10, wherein performing n chemical strengthening treatments on the glass comprises:
shielding the bendable region of the glass by providing a strengthening shielding layer;
performing a first chemical strengthening treatment on the non-bendable region of the glass for a first duration by immersing the glass into a molten first strengthening material at a first predetermined temperature;
removing the strengthening shielding layer and the first strengthening material remaining on a surface of the glass;
performing a second chemical strengthening treatment on the bendable region and the non-bendable region of the glass for a second duration by immersing the glass into a molten second strengthening material at a second predetermined temperature; and
removing the second strengthening material remaining on the surface of the glass.

12. The method according to claim 10, wherein performing n chemical strengthening treatments on the glass comprises:
performing a first chemical strengthening treatment on the bendable region and the non-bendable region of the glass for a first duration by immersing the glass into a molten first strengthening material at a first predetermined temperature;
removing the first strengthening material remaining on a surface of the glass;
providing a strengthening shielding layer that shields the bendable region of the glass, such that the bendable region is prevented from being chemically strengthened;
performing a second chemical strengthening treatment on the non-bendable region of the glass for a second duration by immersing the glass into a molten second strengthening material at a second predetermined temperature;
removing the strengthening shielding layer and the second strengthening material remaining on the surface of the glass;
performing a third chemical strengthening treatment on the bendable region and the non-bendable region of the glass for a third duration by immersing the glass into a molten third strengthening material at a third predetermined temperature; and
removing the third strengthening material remaining on the surface of the glass;
wherein the first duration is less than the second duration, and the third duration is less than the first duration.

13. The method according to claim 8, wherein forming the recess having the predetermined depth by thinning the selected region in the first plane of the glass substrate comprises:
providing a thinning shielding layer configured to shield the non-selected region of the glass substrate, such that the non-selected region is prevented from being etched;
etching the selected region such that the glass substrate is thinned at the selected region by the predetermined depth and the recess is formed; and
removing the thinning shielding layer.

14. The method according to claim 13, wherein etching the selected region such that the glass substrate is thinned at the selected region by the predetermined depth and the recess is formed comprises:
etching an etching region within the selected region to a specified depth;
increasing a width of the etching region by a predetermined value, determining the increased etching region as a new etching region, and etching the new etching region to the specified depth; an
repeating the step of increasing the width of the etching region by the predetermined value until an etching depth is equal to the predetermined depth of the recess.

15. The method according to claim 8, wherein the bottom surface of the recess is parallel to the first plane, and a distance between the bottom surface of the recess and a second plane, away from the first plane, of the glass is greater than or equal to 30 μm and less than or equal to 50 μm.

16. The method according to claim 8, wherein a distance between a side edge, close to the bottom surface of the recess, of an orthographic projection of the side surface of the recess on the first plane and a side edge, away from the bottom surface of the recess, of the orthographic projection of the side surface of the recess on the first plane is greater than or equal to 5 mm and less than or equal to 10 mm.

17. The method according to claim 8, wherein the first arcuate surface and the second arcuate surface are both circular arcuate surfaces, and curvature radii of cross-sections of the two arcuate surfaces are both greater than or equal to 10 mm.

18. The method according to claim 8, wherein the foldable display screen further comprises a transparent filling layer configured to fill the recess, wherein a refractive index of the transparent filling layer is greater than or equal to 1.41 and less than or equal to 1.61.

19. The method according to claim 18, wherein the foldable display screen further comprises a display panel, a cover layer, and a heat dissipation support layer, wherein the cover layer is configured to cover and protect the display panel, and the glass is disposed in the cover layer.

20. The method according to claim 18, wherein a surface of the glass is coated with potassium ions and/or sodium ions.
